(19) United States
(12) Patent Application Publication
(10) Pub. No.: US 2024/0070646 A1
(43) Pub. Date: Feb. 29, 2024

(54) SIMPLIFY VIRTUAL CARD NUMBERS

(71) Applicant: Capital One Services, LLC, Mclean, VA (US)

(72) Inventors: Paul Y. Moreton, Tuscaloosa, AL (US); Philip J. SPIEGEL, Midlothian, VA (US); Lawrence DOUGLAS, Mclean, VA (US); John Oliva GILLING, Brooklyn, NY (US); Chris MARCONI, Richmond, VA (US)

(73) Assignee: Capital One Services, LLC, Mclean, VA (US)

(21) Appl. No.: 18/275,272

(22) PCT Filed: Jan. 31, 2022
(86) PCT No.: PCT/US22/14588

§ 371 Date: Aug. 1, 2023

(30) Foreign Application Priority Data
Feb. 1, 2021 (SG) 10202101039T

(51) Int. Cl. G06Q 20/34; G06Q 20/38

(52) U.S. Cl. CPC G06Q 20/351; G06Q 20/385

(57) ABSTRACT

Disclosed herein are system, method, and computer program product embodiments for generating a virtual card number (VCN) associated with a credit card having a primary account number (PAN). The algorithm used matches the last 4 digits of the VCN to the last 4 digits of the PAN. By matching the last 4 digits of the VCN to the PAN, customer confusion is avoided, and VCNs may be more widely deployed, reducing the number of PAN reissuances that occur. The implementation of this feature is possible using the specific technique disclosed herein that uses multiple, rotating bank identification numbers (BIN) to expand the universe of available PANs to scales that can support a working implementation. The approach further describes accepting both a PAN card verification value (CVV) and a VCN CVV to authorize transactions. The approach also allows the synchronizing of expiration dates between a VCN and a PAN to further ease the burden of administering VCNs.

### BACKGROUND

Consumers increasingly choose to shop at online merchants. These consumers relish in the wealth of goods and services available in the digital realm and embrace the convenience of making purchases from the comfort of their own home or on-the-go on mobile devices. Many rely on a credit card as a payment mechanism, but instead of presenting a physical card at a cash register when checking out, consumers enter credit card information during an online checkout process. These consumers demand the same security in the virtual realm that they are accustomed to in the physical world.

Financial service providers seek to meet these expectations. Such providers offer credit cards and related services to consumers. As consumers continue to become more savvy, knowledgeable, and technologically oriented, providers offer a wide-array of online services. For example, consumers may view their credit card balance, view transactions, pay their bills, report fraud, and perform a litany of other functions in an interactive online experience furnished by the providers.

Under protocols specified by card issuers, credit cards have a primary account number (PAN), an associated card verification value (CVV), and an expiration date. Issuers specify the format that PANs and CVVs must adhere to. For example, the PAN may be a 16-digit number. The first 6 digits of the PAN may be a bank identification number (BIN), and the last digit may be a checksum value. The 9 remaining digits in the middle may be an account identifier. The CVV may be a 3-digit number.

For ease of illustration, this particular embodiment will be referred to throughout the disclosure below. However, numerous embodiments may employ other protocols and conventions within the spirit of this disclosure. For example, a PAN may also be an 18-digit, 20-digit, or other length number. A BIN may be 7 digits, 8 digits, 9 digits, 10 digits, or other suitable length. The checksum value may be 2 digits, 3 digits, etc. These variations in PAN, BIN, and checksum across embodiments result in different length account identifiers, e.g., 5 digits, 6 digits, 7 digits, 8 digits, 9 digits, 10 digits, 11 digits, etc. Similarly, the nature of a CVV may differ and may be 4 digits, 5 digits, etc. Despite these variations, the techniques described below are applicable and useful regardless of the specific format of the PAN and CVV.

The boom in online commerce has led to an increasing amount of credit card fraud and theft. Financial service providers expend enormous resources and energy combatting this malfeasance. Providers must protect information under their control from the hands of those seeking to steal this information. But moreover, certain points-of-failure lie beyond the control of the providers—e.g., many consumers store a PAN and CVV with third-party merchants to facilitate automatic payment of recurring expenses or streamline the checkout process.

Providers may identify when a PAN and/or CVV belonging to a customer becomes compromised. However, after determining that a PAN has been compromised (e.g., through a breach of security at a third-party), the provider must issue a new PAN to the customer. This is a disruptive hassle for the customer. The customer must receive a new credit card in the mail, update their stored information in numerous locations, and suffer diminished spending power until the situation is resolved. Accordingly, providers seek solutions that minimize the number of card reissuances.

VCNs provide one solution to reduce reissuance prevalence. A VCN resembles a PAN and may take the same form—e.g., in one embodiment, a 16-digit number with an associated 3-digit CVV and an expiration date. A VCN may serve the same function as a PAN in that a customer may provide the VCN and a CVV to a merchant and incur an expense against their credit account. In this fashion, the VCN serves a proxy for the PAN. A customer may also associate the VCN with a particular merchant and specify merchant-specific controls. For example, a customer may specify a spending cap or other restrictions on the VCN that specific limited users and afford additional security checks. Subsequent transactions perform merchant-binding to ensure that the appropriate merchant is processing the transaction and that the merchant-specific controls are satisfied.

Importantly, when a transaction occurs using a VCN, the PAN is not exposed, which provides an added layer of security that protects the PAN during the transaction. Moreover, if the third-party stores the VCN and a data breach occurs at the third-party, the PAN is not compromised. In such a scenario, only the merchant-bound VCN is compromised, and the provider may generate a new VCN to cure the issue. The PAN is preserved, re-issuance is avoided, and the customer avoids a tremendous hassle.

However, problems exist preventing the wide-spread adoption of VCNs by customers. In legacy systems, the use of VCNs imposes burdensome management responsibilities on a customer. For example, the customer must manually track the VCNs associated with their PAN. It may be difficult for customers, particularly those with multiple credit cards, to recall which VCNs are associated with which PANs.

Some legacy solutions attempt to provide customers with methods of easily referencing the VCNs associated with their PAN, e.g., web interfaces, lookup tables, etc. However, this adds complexity by introducing additional steps into a checkout process. Customers are unlikely to elect to impose this burden on themselves. While the most security-conscious customer might be willing to take on this burden, the average customer is more likely to reach for their credit card, enter the PAN, and complete the transaction in the fastest way available.

One overarching approach to spur adoption is to automatically create, track, and apply VCNs on behalf of a customer. This approach may employ a browser extension or other suitable programmatic construct to monitor a customer's behavior online. When the customer reaches a checkout page having a credit card number, CVV, and expiration date, the browser extension may generate a VCN (or retrieve an existing VCN) and populate the checkout form with the VCN. This obviates the need for the customer to manage their own VCNs. While potentially spurring wider adoption of VCNs, this approach itself gives rise to several additional technical problems that require technical solutions.

Specifically, customers customarily recognize their credit card account using the last 4 digits of their PAN. This tendency is caused, at least in part, by the fact that for security reasons online merchants and financial service providers obfuscate the first 12 digits of a credit card number on a web page and display only the last 4 digits. So, when a customer views their PAN online, the customer only sees the last 4 digits. Thus, in most customers' minds, the last 4 digits are synonymous with their actual account (in the same way that one identifies/uses the last 4 digits of a social security number as a distinguishing personal characteristic).

When checking out at an online merchant, if a customer sees 4 unrecognizable digits in the credit card field (e.g., populated automatically using a browser extension), the customer may become confused, concerned, and hesitant to complete the transaction. Further, if the customer ultimately completes the transaction, they may not use the VCN associated with the PAN for the account they would have preferred to use. While a more savvy customer may understand that a VCN is being deployed, the savvy customer may still have to use a lookup table or other mechanism to verify the veracity of the information prior to submission.

### BRIEF DESCRIPTION OF THE DRAWINGS

The accompanying drawings, which are incorporated herein and form a part of the specification, illustrate embodiments of the present disclosure and, together with the description, further serve to explain the principles of the disclosure and to enable a person skilled in the arts to make and use the embodiments.

FIG. 1 is a block diagram of a commerce environment, in accordance with an embodiment.

FIGS. 2A and 2B illustrate an exemplary credit card, in accordance with an embodiment.

FIGS. 3A and 3B are screen displays of a virtual card number (VCN) generating and administration interface, according to some embodiments.

FIG. 4 is a screen display of a checkout page incorporating a VCN plugin, according to some embodiments.

FIG. 5 illustrates a method of creating a VCN, in accordance with an embodiment.

FIG. 6 illustrates a method of building a universe of available VCNs and selecting a VCN from the universe, in accordance with an embodiment.

FIG. 7 illustrates a method of authenticating a transaction using multiple CVV numbers against a VCN, in accordance with an embodiment.

FIG. 8 illustrates a method of applying merchant-specific controls to a VCN, in accordance with an embodiment.

FIG. 9 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for generating a VCN associated with a credit card having a PAN where the last 4 digits of the VCN match the last 4 digits of the PAN.

As discussed above, a need exists to generate a VCN with the last 4 digits (or other suitable trailing quantity of digits, in other embodiments) matching the last 4 digits of the PAN. This solves the problem of customers' confusion at checkout because the last 4 digits that display in the checkout form match the customers' expectations (by matching the last 4 digits of the PAN). The customer gets the best of both worlds—the security of using VCNs to prevent theft and the simultaneous, easy identification of their account. With this enhancement in place, a provider may design and deploy a browser extension or other programmatic construct that allow customers to use VCNs automatically, effortlessly, and seamlessly. This approach offers all the security of VCNs, but to the customer appears only to use the familiar PAN. While the foregoing describes a last 4 digits, other implementations expose less or more digits. The below disclosure may reference to the last X digits of a PAN or VCN as a trailing identifier having a trailing quantity of digits.

However, this specific approach (matching last 4 of PAN and VCN) creates more technical problems that require additional, specific technological solutions. As discussed above, a PAN has a fixed number of digits, as specified and standardized by/among credit card issuers and industry participants. In one embodiment, the first 6 digits are reserved for a BIN and the last digit is reserved as a checksum value. If, as described above, the last 4 digits of a VCN are matched to PAN to avoid customer confusion, the number of available account identifiers in the universe of account identifiers becomes problematically small. In this example, only 6 digits remain, providing only one million candidate VCNs. Worse, only a portion of these candidate VCNs may satisfy a checksum algorithm and other security requirements, further restricting the pool of available VCNs. Customers purchase goods at dozens or even hundreds of online merchants (and thus, may require dozens or hundreds of VCNs), and financial service providers have thousands or millions of customers. Accordingly, with such a small universe of available account numbers, generating a functioning implementation through known techniques is an impossibility.

However, a solution to this problem is described below in the form of a cryptographic algorithm selects an available BIN from among a pool of BINs and generates an account identifier using this BIN. This technique relies on a plurality of BINs secured and retained by a provider. The algorithm simultaneously generates a VCN that satisfies the checksum value. This algorithm expands the universe of available VCNs to a level that makes implementation possible.

Another problem arises with CVVs when the last 4 digits of the PAN and VCN match. Under protocols, a provider must create a CVV and associate it with the VCN to allow the VCN to function as a payment mechanism. However, the VCN's CVV will not match the PAN's CVV, even if the last 4 digits match between the PAN and CVV. This creates a further point of confusion for customers who are using the VCN seamlessly and interchangeably with the PAN (or using the VCN through programmatic means, unaware that they are doing so). Specifically, with the last 4 digits of the PAN and VCN displaying indistinguishably on the checkout page, a customer may become confused as to which CVV to enter when prompted by a merchant—the CVV associated with the PAN or the CVV associated with the VCN. Such a scenario breaks the seamless, automatic operation/application of the VCNs via the browser extension. The customer would be forced to understand which VCN/PAN is associated with each merchant and then rely on the legacy technique of accessing a lookup table or keeping track of the CVVs manually to know which CVV to enter to verify the transaction.

However, a technical solution is described below that solves this problem. At checkout, when a VCN is used, the solution allows a transaction to be processed using either the PAN's CVV or the VCN's CVV. By authorizing payments using both CVV's, it is irrelevant which CVV a customer enters as a means of authentication. This solution allows thus the seamless and automatic application of the VCNs to occur—a customer need only remember the CVV associated with the PAN.

Another technical problem arises regarding expiration dates. Like a PAN, each VCN has an expiration date. Some merchants require the expiration date when authenticating an online transaction. A similar problem may arise as described above with CVVs, where the expiration date does not match between the PAN and VCN. This may require the customer to manually intervene. Moreover, a customer may have to manage the many expiration dates across the multitude of VCNs. Each VCN could expire at different times as each unique expiration date arrives. This may be confusing to the customer, as the PAN may still be valid. A customer may need to visit each merchant to update the VCN stored in the merchant site.

A technical solution is described below that solves this problem by synchronizing the expiration date of the VCN with the expiration date of the PAN. An alternative approach is described that sets the expiration date for the VCN to a distant date.

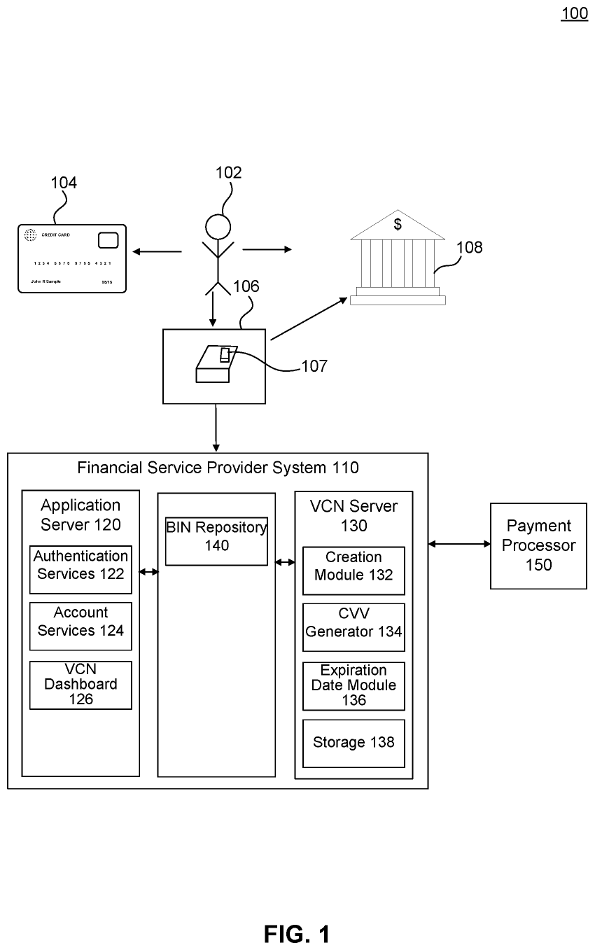

FIG. 1 is a block diagram of a commerce environment 100, in accordance with an embodiment. Any operation herein may be performed by any type of structure in the diagram, such as a module or dedicated device, in hardware, software, or any combination thereof. Any block in the block diagram of FIG. 1 may be regarded as a module, apparatus, dedicated device, general-purpose processor, engine, state machine, application, functional element, or related technology capable of and configured to perform its corresponding operation(s) described herein. Commerce environment 100 may include user 102, credit card 104, device 106, merchant 108, financial service provider system 110, account services component 120, VCN component 130, and payment processor 150.

User 102 may be a consumer, customer, or other individual interacting with financial service providers and purchasing goods and services at merchants. User 102 may connect to a financial service provider system, such as that described below as financial service provider system 110, using a device, described below as device 106. User 102 may transact with a merchant, described below as merchant 108, either in person in the physical world or digitally in the virtual world through an appropriate web browser or other mechanism. User 102 may connect to the merchant and financial service provider using a suitable network such as the Internet, a local area network (LAN), a wide area network (WAN), a wireless network, a cellular network, or various other types of networks as would be appreciated by a person of ordinary skill in the art.

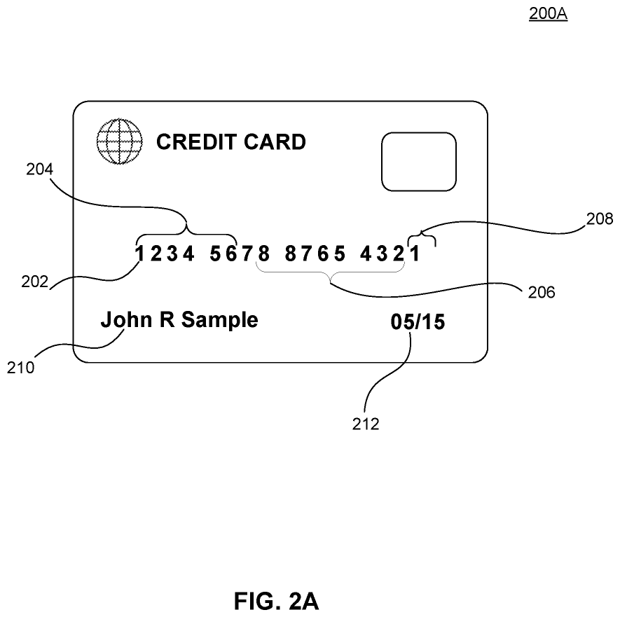

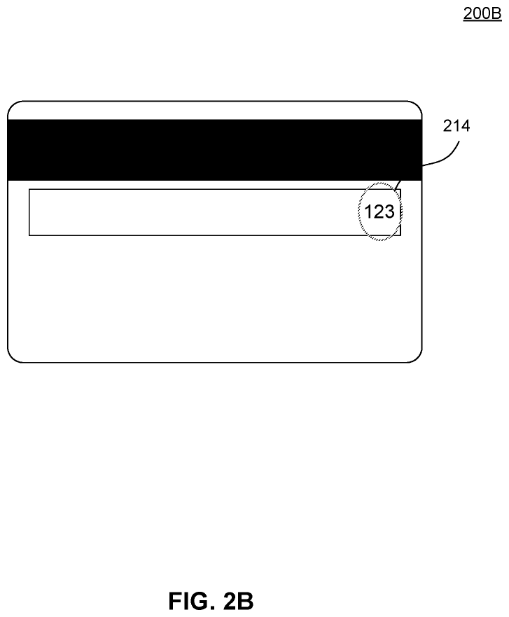

Credit card 104 may be used by user 102 to incur an expense against a credit account. Credit card 104 may represent a physical object, as indicated below in FIG. 2, i.e., an actual tangible card with identifying information thereon that user 102 may use to purchase goods and services. Credit card 104 may include a PAN, a CVV, and an expiration date. The exact format of the PAN and CVV may differ across embodiments. For example, in a commonly used protocol, the PAN may be a 16-digit number. These 16 digits may have dedicated purposes, e.g., the first 6 digits of the PAN may be a BIN, the last digit a checksum value, and the 9 digits in the middle may be an account identifier. When processing a transaction using credit card 104, the Luhn Algorithm (or other suitable approach) may be employed to ensure that the checksum value verifies the prior 15 digits. Such a checksum function ensures that erroneously entered information does not result in an unnecessary processing of a transaction.

Device 106 may be a desktop workstation, laptop or notebook computer, personal digital assistant, netbook, tablet, smart phone, mobile phone, smart watch or other wearable, appliance, part of the Internet-of-Things, and/or embedded system, to name a few non-limiting examples, or any combination thereof. Device 106 may be used by an account holder to conduct commerce online, i.e., to purchase goods and services. In one embodiment, device 106 may include a mobile application installed thereon, which may interact with a financial service provider system to view account information, transactions, etc., and interact with third-party systems provided by merchants. Device 106 may include a web-browser. The web browser may support downloadable browser extensions or other downloadable software modules, such as that described next as browser extension 107, to offer additional functionality beyond basic web browsing and provide a more dynamic web-browsing experience.

Browser extension 107 may create, track, and apply VCNs automatically for user 102. In an embodiment, browser extension 107 may operate as a program within a web browser used by user 102. However, in other embodiments, different programmatic approaches to providing this functionality make be taken. For example, in some embodiments, browser extension 107 may be operate as a component of webpage offered by a financial service provider or stand-alone application. In another embodiment, browser extension 107 may operate as an extension to a browser on a mobile device, operate as a component of the operating system running on the mobile device, be deployed within the code of a mobile application running on a mobile device, or function a deep link to a mobile banking application. Browser extension 107 may monitor the behavior of user 102 when user 102 conducts commerce online. When user 102 reaches a checkout page provided by merchant 108, browser extension 107 may recognize fields relevant to conducting a transaction in the form, e.g., a credit card number, a CVV, and an expiration date. Browser extension 107 may then determine if an applicable VCN exists for the relevant merchant. If so, browser extension 107 may populate the appropriate fields in the checkout form with the VCN, CVV, and/or expiration date. If no VCN exists, browser extension 107 may then offer user 102 the ability to create a VCN for the merchant. Post creation, browser extension 107 may populate the appropriate fields with the newly created VCN. These capabilities are described in greater detail below.

Merchant 108 may be a business, organization, individual, or other suitable entity that sells, rents, or otherwise offers goods or services in the stream of commerce. One skilled in the arts will appreciate that merchant 108 may provide a far-reaching range of goods and services—anything that may be purchased with a credit card. Merchant 108 may operate a brick-and-mortar store at which user 102 may purchase goods or services in the conventional fashion—i.e., by presenting credit card 104 at a cash register during checkout. Merchant 108 may also provide an online shopping experience through which user 102 may browse an inventory and make purchases using device 106. This experience may be web-browser based, a mobile application, or operate in another suitable mechanism through which user 102 may shop, explore, and purchase goods. The online experience may include a checkout page in which user 102 enters and confirms their credit card information to complete a purchase. Merchant 108 may leverage a variety of third-party tools as a mechanism for presenting their products and receiving payment for their products. However, to streamline the disclosure, merchant 108 will be treated below as being a single entity. The below disclosure will discuss VCNs in detail—from the perspective of merchant 108, a VCN is indistinguishable from a PAN—both provide valid, interchangeable methods of completing a transaction against credit card 104.

Financial service provider system 110 may be maintained by a financial service provider. Financial service provider system 110 may offer banking services to customers, including credit cards. Financial service provider system 110 may manage credit card 104 for user 102 and provide a variety of related services. Financial service provider system 110 may allow user 102 to view their credit card balance, view transactions, pay their bills, report fraud, etc. Financial service provider system 110 may provide a wide-range of other capabilities to user 102 that extend beyond the scope of this disclosure. As described below, financial service provider system 110 may also generate, manage, and apply VCNs for use in place of a PAN associated with credit card 104. Financial service provider system 110 may include account services component 120, VCN component 130, and BIN repository 140.

Account services component 120 may be leveraged by financial service provider system 110 to provide a variety of online services to user 102. These services may address an account of user 102 associated with credit card 104. For example, user 102 may access account services component 120 to review of their account, make monthly payments, review past transactions, and perform other suitable functions. In one embodiment, account services component 120 may allow user 102 to download and install browser extension 107 to perform various features related to VCN creation, management, and application. Account services component 120 may include authentication services 122, general services 124, and VCN dashboard 126.

Authentication services 122 may be used by financial service provider system 110 to verify the identity of user 102 at login and other appropriate times. Authentication services 122 may authorize connections to financial service provider system 110 using username/password combinations. In some embodiments, authentication services 122 may employ an alternate authentication methodology, such as two-factor authentication, token authentication, biometric data, etc., to identify, authorize, encrypt, and account for user connections. Authentication services 122 may also interact with browser extension 107 at login or on an ongoing basis to appropriately authorize transactions conducted using browser extension 107.

General services 124 may provide to user 102 general services and functions related to credit card 104. For example, general services 124 may allow user 102 to view the current balance, render payment, and review past transactions. In some legacy systems, general services 124 may provide a lookup table to view created VCNs, their associations with merchants, expiration dates, and CVVs so that user 102 may manually provide VCNs to retailers, both online and in person. General services 124 may include a wide-array of other functions beyond the scope of this disclosure.

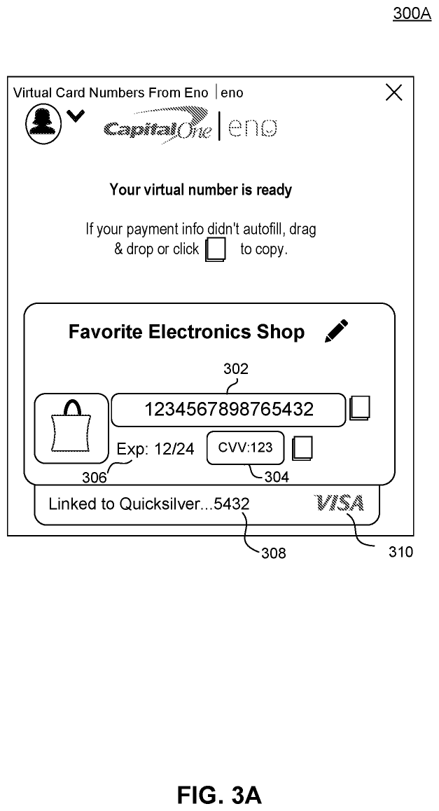

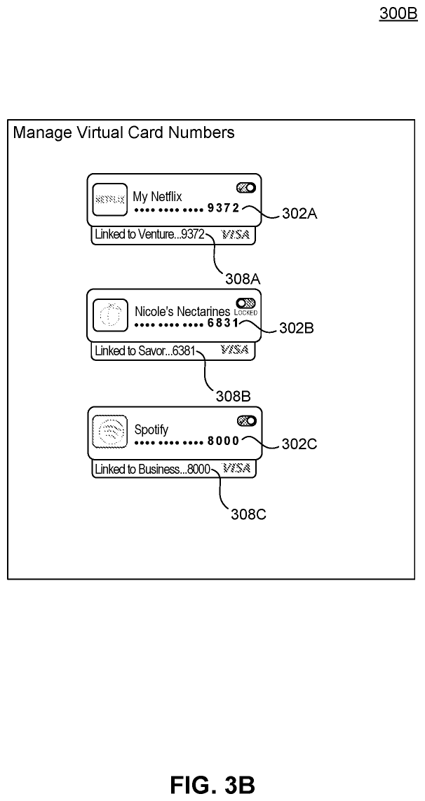

VCN dashboard 126 may allow user 102 to manage VCNs by engaging VCN component 130, described in further detail below. In some legacy systems, VCN dashboard 126 may provide a lookup table to view created VCNs, their associations with merchants, expiration dates, and CVVs. VCN dashboard 126 may also allow user 102 to impose merchant specific controls against the VCNs that have been created. In some embodiments, VCN dashboard 126 may allow user 102 to create a new VCN by engaging creation module 132. An exemplary illustration of VCN dashboard 126 is discussed in further detail below with reference to FIG. 3B.

VCN component 130 may be leveraged by financial service provider system 110 to create VCNs and store related information. VCN component 130 may include creation module 132, CVV generator 134, expiration data module 136, and storage 138.

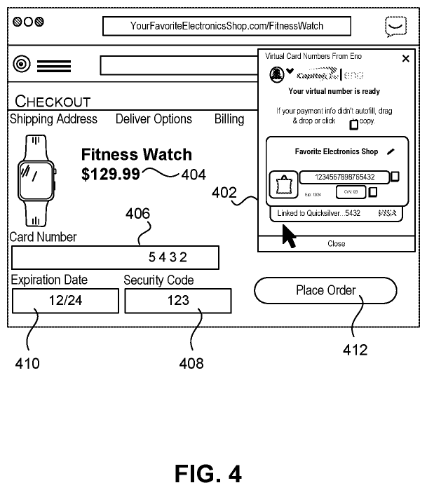

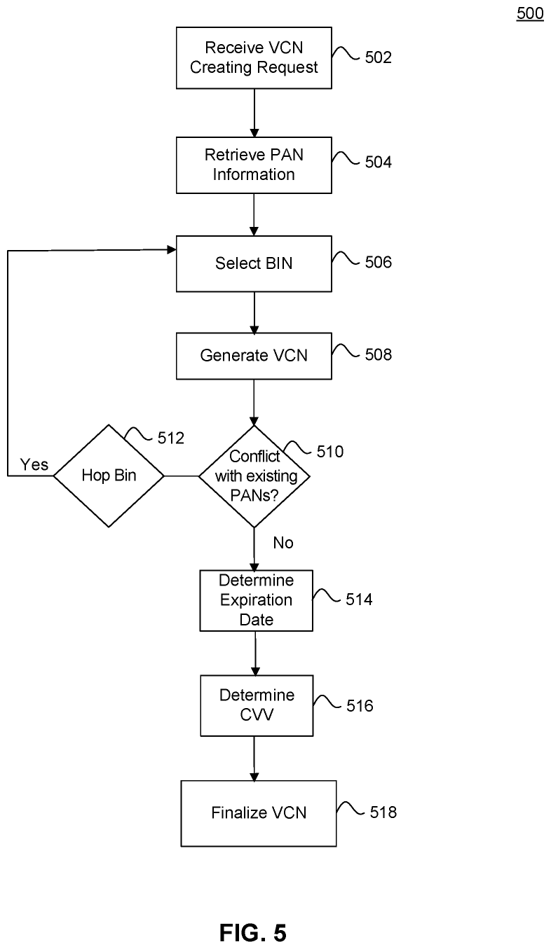

Creation module 132 may create a VCN. To create a VCN, VCN creation module 132 may employ the specific approaches described below in FIGS. 4 and 5. However, other suitable implementations may be employed by creation module 132 within the context of this disclosure. After creating the VCN, creation module 132 may provide the information (VCN, CVV, expiration date) to account services component 120 and/or browser extension 107 and store the information for later application/recall, e.g., in storage 138.

CVV generator 134 may be employed by VCN component 130 and/or creation module 132 to create a CVV for use in association with a VCN. Under existing protocols, financial service provider system 110 must create a CVV and associate it with the VCN being created to allow the VCN to function as a payment mechanism. After creating the CVV, CVV generator 134 may provide the CVV to account services component 120 and/or browser extension 107 and store the information for later application/recall, e.g., in storage 138.

Expiration date module 136 may be employed by VCN component 130 to determine an expiration date for a VCN. Though appearing as a separate module, in other embodiments, the expiration date may be determined by creation module 132. After determining the expiration date, expiration date module 136 may provide the date to account services component 120 and/or browser extension 107 and store the information for later application/recall, e.g., in storage 138.

Storage 138 may store a variety of information about VCNs that have been created by user 102. Storage 138 may store an association between a PAN and one or more VCNs. Storage 138 may store the CVVs and expiration dates associated with the created VCNs. Storage 138 may provide a mechanism, e.g., an application programming interface or other micro-service, through which account services component 120 and/or VCN dashboard 126 may access information about VCNs for display/editing by user 102. Storage 138 may employ any of a panoply of data storage system to store the relevant information.

BIN repository 140 may store one or more BINs retained, owned, licensed, or otherwise available to financial service provider system 110. In one embodiment, BIN repository 140 may associate stored BINs in a hierarchy, with certain BINs being prioritized ahead of other BINs. The characteristics and nature of a BIN stored in BIN repository 140 is described in further detail below as BIN 204.

Payment processor 150 may be a payment processing network that issues credit cards, such as credit card 104, through a member financial institution, such as financial service provider system 110. For example, payment processor 150 may be VISA, MASTERCARD, AMERICAN EXPRESS, etc. Payment processor 150 may further provide mechanisms by which transactions incurred using credit card 104 are verified, authenticated, applied, and tracked, and payment rendered between transacting parties.

FIGS. 2A and 2B illustrate an exemplary credit card 200, in accordance with an embodiment. FIG. 2A illustrates credit card front 200A, and FIG. 2B illustrates credit card back 200B. These illustrations are merely exemplary, and one skilled in the relevant art(s) will appreciate that many approaches may be taken to provide a suitable credit card 200 in accordance with this disclosure. Exemplary credit card 200 includes PAN 202, BIN 204, account identifier 206, checksum 208, account holder 210, expiration date 212, and CVV 214.

PAN 202 uniquely identifies credit card 104. The exact format of PAN 202 may vary across embodiments. In the exemplary illustration in FIG. 2A, PAN 202 is a 16-digit number. For ease of illustration, this particular embodiment will be referred to throughout the disclosure below. However, numerous embodiments employ other protocols and conventions within the context of this disclosure. For example, the techniques described in this disclosure are equally applicable to a PAN having 18 digits, 19 digits, 20 digits, or other suitable number of digits.

BIN 204 uniquely identifies the financial institution that issued credit card 104. BIN 204 may also signify the issuer's industry. One skilled in the arts will appreciate that a finite number of BINs exist and that a BIN is a scarce and valuable resource. In the exemplary illustration in FIG. 2A, BIN 204 is a 6-digit number. For ease of illustration, this particular embodiment will be referred to throughout the disclosure below. However, numerous embodiments employ other protocols and conventions within the context of this disclosure. For example, the techniques described in this disclosure are equally applicable to a BIN having 7 digits, 8 digits, or other suitable number of digits.

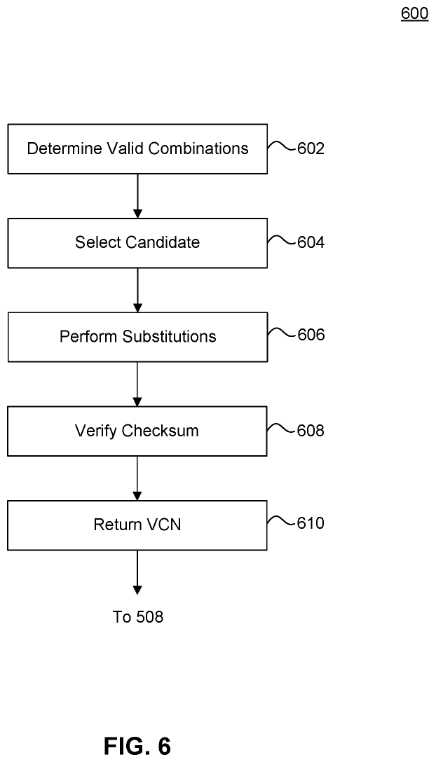

Account identifier 206 is a variable-length integer that may be combined with BIN 204 and checksum 208 to form a valid PAN, such as PAN 202. In the exemplary illustration in FIG. 2A, account identifier 206 is a 9-digit number. For ease of illustration, this particular embodiment will be referred to throughout the disclosure below. However, numerous embodiments employ other protocols and conventions within the context of this disclosure. For example, the techniques described in this disclosure are equally applicable to account identifiers having 8 digits, 10 digits, or other suitable number of digits. Account identifier 206 may be calculated such that conflicts are avoided among existing issued PANs and VCNs and such that the last 4 digits of the PAN match the last 4 digits of the VCN, as described in further detail below with reference to FIGS. 5 and 6.

Checksum 208 provides a redundancy check used to identify errors in entered credit card information. This avoids the running of authentication procedures at payment processor 150 using inappropriately entered credit card information. In one approach, the preceding digits in PAN 202 serve as inputs used to generate checksum 208 via an appropriate checksum formula or algorithm. For example, the Luhn Algorithm may be employed to calculate the checksum value. The Luhn Algorithm is a public domain approach that may be used to detect errors in entry in the preceding digits. In the exemplary illustration in FIG. 2A, checksum 208 is a single digit. For ease of illustration, this single-digit embodiment will be referred to throughout the disclosure below. However, other embodiments may be implemented within the scope of this disclosure in which checksum 208 is a 2-digit number, 3-digit number, or other suitable length.

Account holder 210 may be a name of the owner of credit card 104, i.e., an identifier signifying user 102. Account holder 210 may be a full name, or in other embodiments, another suitable identifier. In some embodiments, account holder 210 may provide another degree of authentication when conducting a transaction at payment processor 150.

Expiration date 212 may be a date associated with PAN 202 at which payment processing will no longer function against credit card 104 using PAN 202. Expiration date 212 may serve to prevent fraud by offering another data point in authenticating a transaction that uses credit card 104. Expiration date 212 may also compel user 102 to adopt additional technologies over time.

CVV 214 adds another layer of security to credit card transaction processing. In the exemplary illustration in FIG. 2B, CVV 214 has 3 digits. In alternative embodiments, CVV 214 may be other suitable lengths. Moreover, while FIG. 2B illustrates credit card back 200B with CVV 214 displayed thereon, in other embodiments, CVV 214 may be displayed in other suitable locations, e.g., on credit card front 200A.

FIGS. 3A and 3B are screen displays of generating agent 300A and VCN dashboard 300B, according to some embodiments. The screen displays provided in FIGS. 3A and 3B are merely exemplary, and one skilled in the relevant art(s) will appreciate that many approaches may be taken to provide generating agent 300A and VCN dashboard 300B, or other appropriate interfaces, in accordance with this disclosure.

Generating agent 300A includes VCN 302, virtual card CVV 304, virtual card expiration date 306, linked PAN 308, and issuer 310. Generating agent 300A may be operate as part of browser extension 107, as part of website offered by general services 124, independently, or in other suitable fashion.

VCN 302, generated by creation module 142 and displayed in generating agent 300A, takes the same form as PAN 202. In one embodiment, VCN 302 is a 16-digit number. In other embodiments, VCN 302 otherwise matches the length and format of PAN 202. Subsequently, a customer may provide VCN 302 to a merchant and incur an expense against credit card 104. In this fashion, VCN 302 provides a secure mechanism of transaction against an account without exposing PAN 202. VCN 302 may be created by user 102 using financial service provider system 110 or VCN 302 may be created by browser extension 107, which automatically recognizes that user 102 is on a webpage of merchant 108 having a credit card field. In some embodiments, user 102 may provide VCN 302 to merchant 108 in person, over the phone, or using any other suitable approach. FIG. 3A illustrates that the last 4 digits of VCN 302 match the last 4 digits of PAN 202. This capability—matching a trailing quantity of digits of the VCN to the PAN—is made possible using the techniques described in further detail below with reference to FIGS. 5 and 6.

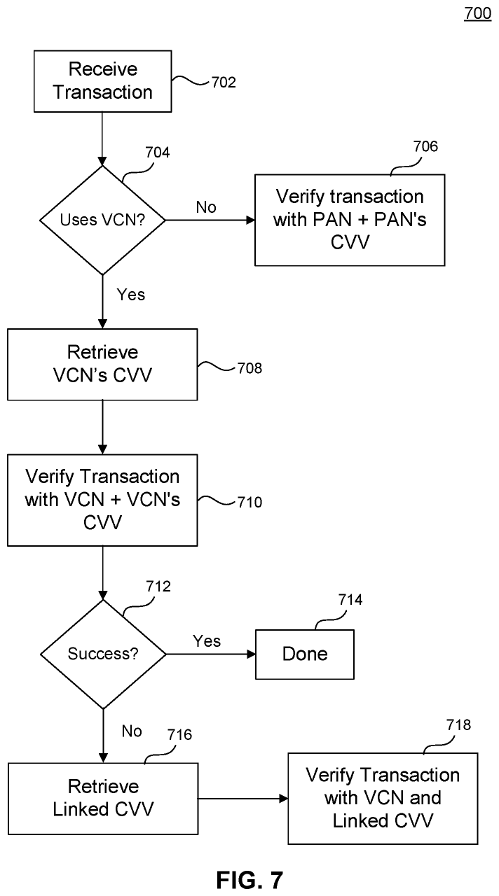

Virtual card CVV 304 may be created by CVV generator 144. Virtual card CVV may take the same form as the CVV associated with PAN 202, i.e., CVV 214. For example, virtual card CVV may be a 3-digit number. However, in other embodiments, virtual card CVV may have 4 digits, 5 digits, etc. Virtual card CVV 304 may be used in tandem with VCN 302 to provide enhanced security over transactions performed using VCN 302 against credit card 104. As discussed below with reference to FIG. 7, financial service provider system 110 may employ a technique in which either virtual card CVV 304 or CVV 214 may be used to authenticate a transaction using VCN 302. As an alternative to the dual processing of the CVVs (i.e. the virtual card CVV and a linked CVV of the PAN) described in further detail below in FIG. 7, CVV generator 144 may generate virtual card CVV 304 to match the CVV associated with the PAN, i.e., CVV 214. In this embodiment, virtual card CVV 304 and CVV 214 will be identical numbers. By matching virtual card CVV 304 to CVV 214, the customer only needs to recall a single CVV to complete a transaction at merchant 108, regardless of whether the customer uses PAN 202 or VCN 302 to complete the transaction.

Virtual card expiration date 306 may be created or modified by expiration date module 146. Virtual card expiration date 306 may represent a date at which VCN 302 no longer may be used to process transactions. In one embodiment, virtual card expiration date 306 may be synchronized at creation to match the expiration date of the PAN, i.e., expiration date 212. In another embodiment, virtual card expiration date 306 may be set to a distant date, i.e., a date that is far in the future. In this embodiment, user 102 does not need to be concerned about expiration of VCNs. In this embodiment, the distant date may need to be set to a date that will still be acceptable to payment processor 150. For example, the distant date may be set to 10 years in the future, 20 years in the future, etc.

Linked PAN 308 may represent the credit card account or PAN 202 linked to VCN 302. Linked PAN 308 may display a portion of PAN 202, where PAN 202 and VCN 302 reflect the same underlying card account. Linked PAN 308 may only display a trailing quantity of digits, e.g., 4-digits, 5-digits, etc. The current convention is to display 4-digits, but the techniques disclosed below are equally applicable to more or less digits. Linked PAN 308 demonstrates the tendency among providers and merchants to display only the last 4 digits of a PAN, such as PAN 202. This tendency creates a mental association in the mind of user 102 between only the last 4 digits of PAN 202 and their account. In FIG. 3A, the last 4 digits of linked PAN 308, “5432,” match the last 4 digits of VCN 302.

Issuer 310 may designate the payment processor, e.g., payment processor 150 associated with credit card 104. The issuer designated by issuer 310 may authenticate transactions conducted using credit card 104 and transfer payment between the appropriate parties.

VCN dashboard 300B may display information for user 102 about previously created VCNs. FIG. 3B is merely exemplary and many suitable interfaces may be provided to convey this information to user 102. VCN dashboard 300B further illustrates the capabilities described below whereby a trailing quantity of digits in a trailing identifier (4 digits in FIG. 3B) for VCN 302, i.e., VCN 302A, VCN 302B, and VCN 302C, may be matched to the trailing quantity of digits of PAN 202, i.e., linked PAN 308A, linked PAN 308B, and linked PAN 308C. For example, the last 4 digits of VCN 302A, “9372,” match the last 4 digits of linked PAN 308A. VCN dashboard 300B may include a wide-array of additional functionality.

FIG. 4 is a screen display of a checkout page 400 incorporating a VCN plugin/interface/browser extension, according to some embodiments. The screen display provided in FIG. 4 is merely exemplary, and one skilled in the relevant art(s) will appreciate that many approaches may be taken to provide a suitable screen display 400 in accordance with this disclosure. Checkout page 400 may be provided to or accessed by user 102 when purchasing a good or service from merchant 108. Checkout page 400 includes plugin 402, item 404, card number 406, security code 408, form date 410, and order button 412.

Plugin 402 provides an exemplary illustration of a generating agent, such as generating agent 300A. Plugin 402 may operate in a web browser or as a standalone component. In one embodiment, plugin 402 may operate as browser extension 107. In this embodiment, plugin 402 may be inactive and/or undisplayed until user 102 views a checkout page having fields relevant to completing a purchase. At that point, plugin 402 may recognize the relevant fields and provide an interface with which user 102 may interact. Plugin 402 may resemble generating agent 300A, discussed above, include similar fields, and provide similar functionality.

Item 404 may be a good or service that user 102 may purchase from merchant 108. Item 404 may include price, quantity, description, images, and other suitable references to the item at the heart of the transaction. FIG. 4 is merely exemplary, but in FIG. 4 item 404 is a “Fitness Watch” having a cost of “$129.99.”

Card number 406 may be a field in a webpage, mobile application form, or other suitable construct provided by merchant 108 to complete a transaction. User 102 may enter PAN 202 or VCN 302 into card number 406. In an embodiment, card number 406 may be auto-populated by browser extension 107. In FIG. 4, card number 406 illustrates the tendency of merchants to obfuscate all by a trailing quantity of digits (here, 4) in the credit card number to avoid theft.

Security code 408 may be a field in a webpage, mobile application, or other suitable construct provided by merchant 108 to complete a transaction. User 102 may enter CVV 214 or virtual card CVV 304 into security code 408. In an embodiment, security code 408 may be auto-populated by browser extension 107.

Form date 410 may be a field in a webpage, mobile application, or other suitable construct provided by merchant 108 to complete a transaction. User 102 may enter an expiration date into the field, either expiration date 212 or virtual card expiration date 306 into the field, depending on whether PAN 202 or VCN 302 is used. In an embodiment, form date 410 may be auto-populated by browser extension 107. In some embodiments, form date 410 may be omitted from checkout page 400.

Order button 412 may allow user 102 to complete the transaction. Engaging order button 412 may engage financial provider system 110 and/or payment processor 150 to verify and authorize the transaction and finalize payments between accounts.

FIG. 5 illustrates a method 500 of creating a VCN, in accordance with an embodiment. Method 500 demonstrates an algorithm that allows financial service provider system 110 to leverage multiple BINs stored in BIN repository 140 when generating VCNs, such as VCN 302, that have a trailing quantity of digits that match those of the associated PAN. By selecting an appropriate BIN from among a pool of BINs and generating an account identifier using this BIN in a manner that satisfies the checksum value, financial service provider system 110 may generate VCNs with matching last 4 digits at requisite scales. Method 500 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 5, as will be understood by a person of ordinary skill in the art(s).

In 502, financial service provider system 110 may receive a request to create a VCN. The request may include sufficient information to identify user 102 and a credit card account associated with user 102 to associate with the VCN. In one embodiment, financial service provider system 110 receives the request from browser extension 107. In such an embodiment, browser extension 107 may recognize that user 102 has visited a checkout page to purchase a good or service from merchant 108. For example, browser extension 107 may recognize card number 406, security code 408, and form date 410 in a checkout page such as that described above as checkout page 400. In an alternative embodiment, user 102 may initiate the creation request via general services 124 in anticipation of completing a transaction using the VCN. In this alternative embodiment, user 102 may create the request via general services 124 and/or VCN dashboard 126. In another embodiment, user 102 may use a mobile application on device 106 to transmit the creation request. For example, user 102 may generate the VCN on their mobile device in anticipation of visiting a cash register at a physical store of merchant 108 and providing the VCN directly to merchant 108.

In 504, financial service provider system 110 and/or creation module 132 may retrieve information for the individual creating a VCN, i.e., user 102. In one approach, the request may contain identifying information for user 102, and financial service provider system 110 may retrieve a PAN for user 102 based on the user-identifying information. In another approach, the PAN may be transmitted in the creation request by browser extension 107 or another suitable creating entity. Financial service provider system 110 may also retrieve additional information needed to generate a functioning VCN. Such information may include expiration dates, CVVs, user information, etc., in addition to the PAN of the linked account.

In 506, creation module 132 may select a BIN from the BINs available to provider service provider system 110 and stored in BIN repository 140. In one approach, a BIN in BIN repository 140 may be selected in accordance with a hierarchy that specifies a preference among BINs. For example, a particular BIN may be the preferred BIN of the financial service provider and assigned a priority of one, with the remaining BINs assigned a priority of two. In this approach, the preferred BIN would be used first to determine if a VCN may be generated with the last 4 digits matching the last 4 digits of the PAN without generating a conflict (as described in subsequent steps). In one embodiment, a cap may be applied to the number of VCNs that may be created within a particular BIN. In such an embodiment, when the number of VCNs in the BIN exceeds the cap, creation module 132 may be foreclosed from selecting that BIN for provisioning VCNs until the cap raises. Other suitable approaches apply, e.g., a percentage may be associated with the BIN, a round robin algorithm may be used, or another suitable weighted approach. In another exemplary approach, a BIN may be selected randomly. Other approaches to selecting a BIN from among the BINs in BIN repository 140 may be employed within the scope of this disclosure.

In 508, creation module 132 may engage VCN component 130 and/or creation module 132 to generate a candidate VCN. Creation module 132 may select an account identifier having a trailing quantity of digits (e.g., the last 4 digits) that match the last 4 digits of the PAN retrieved in 504. Numerous approaches may be employed to select the account identifier. One overarching approach is to build a data structure of all of the VCNs that satisfy the Luhn Algorithm for each particular BIN in BIN repository 140 and each possible trailing identifier. In another approach, a universe of available VCNs may be determined at runtime using the particular BIN and last four digits as input. In either approach, a candidate VCN is selected from the universe of available VCNs for consideration in subsequent steps. Several exemplary approaches to performing this step are described with more specificity below with reference to FIG. 6.

In 510, creation module 132 may check existing PANs and VCNs to determine if the candidate VCN created in 508 conflicts with an existing PAN or VCN. A VCN is unique when it does not match another PAN or VCN that is in circulation, i.e. being used by a customer. In alternative embodiments, this verification may occur when generating the universe of available VCNs. In other words, a pre-computed data structure of available VCNs for a particular BIN may omit VCNs that are already in circulation. If a conflict does not exist, then method 500 may proceed to 514. If a conflict does exist, then method 500 may proceed to 512.

In 512, creation module 132 may determine if a BIN-hop needs to occur—i.e., if a different BIN in BIN repository 140 needs to be selected. Creation module 132 may employ many suitable approaches to determine if a bin-hop should occur. In one approach, randomness may be employed to select a new BIN at randomly determined intervals. In another approach, a counter may be used to track the number of attempts prior to a BIN hop, e.g., creation module 132 may make 10 attempts within a BIN before transitioning to a different BIN. If a BIN-hop should occur, then method 300 proceeds to 506 to select a new BIN. If no BIN-hop need occur, then method 500 proceeds to 508 to generate a new candidate VCN using the current BIN.

In 514, creation module 132 and/or expiration date module 136 may determine an expiration date to associate with the new VCN. In one embodiment, expiration date module 136 may synchronize the expiration date of the VCN with the expiration date of the PAN retrieved in 504. In an alternative embodiment, expiration date module 136 determines a distant date that is as far as possible into the future, while meeting the protocols specified by payment processor 150. For example, expiration date module 136 may select a distant date of Dec. 30, 2099. In another example, expiration date module 136 may set the distant date to 10 years in the future, 20 years in the future, etc., in accordance with protocols specified by payment processor 150. Other methods of determining the expiration date may be employed within the scope of this disclosure.

In 516, creation module 132 and/or CVV generator 134 may determine a CVV for association with the new VCN. Different approaches may be employed to generate the CVV. In one exemplary approach, the CVV may be generated using particular digits in the VCN, e.g., the 4^{th}, 8^{th}, and 12^{th} digits in the VCN may be combined to form the CVV. However, the actual approach for generating the CVV may be proprietary and unique to payment processor 150 and/or financial services provider system 110, for the purposes of allowing the CVV to secure transactions.

In 518, creation module 132 may finalize the VCN. The VCN created in 508 (and verified unique in subsequent steps, the CVV generated in 516, and the expiration date 514 may be stored in storage 138 may be stored in association with one another. The VCN may be returned to the requestor, for example, for population on the checkout page of merchant 108. In one embodiment, a mobile application running on device 106 may push the generated VCN directly to a database or application programming interface provided by merchant 108.

FIG. 6 illustrates a method 600 of building a universe of available VCNs and selecting a VCN from the universe, in accordance with an embodiment. In an embodiment, method 600 may detail approaches to performing step 508, discussed above with reference to method 500. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 6, as will be understood by a person of ordinary skill in the art(s).

The below description of method 600 may refer to 16-digit VCNs having 6-digit BINs and a last 4 digits that match the PAN. However, this particular embodiment is used for ease of explanation and numerous alternate embodiments exist (e.g., 20-digit VCNs, 8-digit BINs, etc.) to which the method described may be applied with subtle adjustments to the number of digits used for each field.

In 602, VCN component 130 may build a universe of valid VCNs. In one approach, the universe may be specific to a particular 6-digit BIN and a particular last 4 digits. For example, the 6-digit BIN may be selected in step 506 and the last 4 digits may match the last 4 digits of the PAN retrieved in 504. In another approach, the universe may list all valid VCNs for the particular 6-digit BIN. In another approach, all valid VCNs may be included in the universe for all BINs in BIN repository 140.

In determining the universe, creation module 132 may be constrained by the fact that 10 digits (the 6-digit BIN and last 4 digits) of the VCN need to be fixed and cannot be modified. The sum of the fixed digits may be referred to below as “F.” The remaining 6 digits are variable, and the sum of the variable 6-digits may be referred to below as “V.” If zero constraints were applied, in this example, creation module 132 may have 1 million possible choices (0-999,999) to select from across the variable 6-digits. However, creation module 132 must also select 6 variable digits that satisfy the checksum algorithm. In one suitable approach using the Luhn Algorithm, “F”+“V” must equal a sum that is divisible by 10. This constraint reduces the 1 million possible choices by a factor of 10.

For illustration purposes, one suitable approach to performing the checksum algorithm is displayed below:
d={0: 0, 1: 2, 2: 4, 3: 6, 4: 8, 5: 1, 6: 3, 7: 5, 8: 7, 9: 9}
def get_luhn(s):
sum=0;
for i in range (len(s)):
   if (i % 2)==0:
      sum+=d[int(s[i])]
   else
      sum+=int(s[i])
return (sum %10)==0
   The function “get_luhn(s)” described below will be referenced in the approaches detailed below. One skilled in the relevant art(s) will appreciate that the above is a version of the Luhn Algorithm, in which every other digit is doubled. Under such a substitution (i.e., “d” above), 0-4 become the even numbers, and 5-9 become the odd numbers. For example, a 5 becomes a 1 (5×2=10, 1+0=1), a 6 becomes a 3 (6×2=12, 1+2=3), etc.

Generally speaking, creation module 132 may employ a variety of approaches to determine the universe of valid VCNs that: (1) have a first 6 digits matching the 6-digit BIN; (2) have a last 4 digits matching the PAN; and (3) still satisfy the checksum algorithm. In one approach, creation module 132 may pre-compute a data structure of all of the account identifiers (i.e., the 6 variable digits having sum “V”) that satisfy the checksum algorithm. Creation module 132 may build the data structure considering candidates across each BIN in BIN repository 140. In such an approach, creation module 132 may programmatically build the data structure by employing a suitable algorithm, such as the example algorithm reproduced here in pseudocode:
validVCNs=
// cycle through each BIN in BIN Repository 140
for each BIN in binRepo:
   // cycle through each possible last 4 digit
   for each i in range (1000):
      // cycle through each possible middle 6
      for each j in range (1000000):
         VCN=BIN+str(j).zfill(6)+str(i).zfill(4)
         if get_luhn(s): // references above function
         push (VCN, validVCNs.BIN.i)
            In this example, the “validVCNs” list is keyed by BIN and last 4 digits to allow for lookup in subsequent steps on the basis of BIN and last 4 digits. However, in some embodiments, creation module 132 may organize the data structure to include all valid VCNs for a particular BIN, all VCNs across all BINs, or any other suitable organizational approach.

In another approach, creation module 132 may determine the universe of available VCNs at runtime for a particular BIN and last 4 digits. For example, a function may be deployed that receives a BIN (e.g., as selected in 506) and a last 4 digits (e.g., of the PAN as retrieved in 504) as parameters and returns an array of available VCNs that match those parameters. In such an approach, creation module 132 may programmatically build the data structure by employing a suitable algorithm, such as the example algorithm reproduced here in pseudocode:
def getVCNs(BIN, last Four):
validVCNs=
for each j in range (1000000): // cycle through middle 6 candidates
   VCN=BIN+str(j).zfill(6)+last Four
   if get_luhn(s): // references above function
      push (VCN, validVCNs)
return validVCNs

In some embodiments, these approaches may also employ a lookup, e.g., to storage 138 or other location or a call to an appropriate application programming interface to determine if the VCN generated conflicts with a VCN already deployed when determining the universe. In such an embodiment, the universe of VCNs may omit VCNs that are already in circulation. However, as discussed above, these steps may also be performed after retrieving the candidate in 604 or after returning the VCN in 606. Accordingly, method 600 may function iteratively in some embodiments.

In 604, creation module 132 may select a candidate from the universe of VCNs built in 602. Numerous approaches may be employed to select the candidate VCN from the universe of VCNs. For example, in one approach, creation module 132 may select the candidate VCN in sequential order, e.g., in ascending or descending order. In another approach, the candidate VCN may be selected randomly. Random selection may enhance security by making it less predictable to fraudsters to anticipate which VCN will be generated. Other advanced forms of cryptography may be employed to select a candidate VCN based on information known to the system about the user, e.g., the PAN's expiration date, CVVs, zip codes, etc. Other approaches may be employed to select a candidate VCN in a secure fashion. In some embodiments, creation module 132 may perform conflict resolution at this stage, i.e., creation module 132 may perform an appropriate look up to see if a candidate VCN is unique. A VCN may be unique when the VCN is not currently in circulation (i.e., already a PAN or VCN being used by a customer). Many suitable approaches may be employed to optimize the lookup within the pre-computed data structure, e.g., hashing, compression, cryptography, etc.

In 606, creation module may return the candidate VCN. For example, the candidate VCN may be generated in the context of method 500, in which case method 500 proceeds to 510 to consider the candidate VCN and complete the VCN generation process.

FIG. 7 illustrates a method 700 of authenticating a transaction using multiple CVV numbers against a VCN, in accordance with an embodiment. In one embodiment, the CVV for the VCN is matched to the CVV for the PAN when the VCN and CVV are generated. In another embodiment, the CVV for the PAN is linked to the VCN to allow for transaction processing against the VCN using either the PAN's CVV or the VCN's CVV. This feature helps to avoid user confusion when the last 4 digits of a VCN and PAN are matched (as discussed above). By authorizing payments against the VCN using both the CVV of the VCN and the CVV of the PAN, a user may enter either as a means of authentication. Thus, the automatic generation and application of VCNs may occur without the user having to remember multiple CVVs.

Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 7, as will be understood by a person of ordinary skill in the art(s).

In 702, financial service provider system 110 may receive a transaction conducted by user 102 at merchant 108. For example, user 102 may purchase a good or service from merchant 108. In one embodiment, user 102 may complete the transaction online via device 106 in a web browser viewing a web page provided by merchant 108. In another embodiment, user 102 may complete the transaction on their mobile device, e.g., using a mobile application or mobile browser. In another embodiment, user 102 may conduct the transaction at a physical location, and merchant 108 may transmit the transactional information to financial service provider system 110. The transactional information received by financial service provider system 110 may include a credit card number (a PAN or a VCN), a CVV, an expiration date, information about the items/services purchased, cost information, personal information such as date of birth and zip code, and any other suitable fields. In one use case, a credit card information field and other suitable fields (e.g., CVV, expiration date, zip code, etc.) may be populated by a suitable application, e.g., browser extension 107 or an application running on a mobile device.

In 704, financial service provider system 110 may determine if the transaction received in 702 uses a PAN or a VCN. If a PAN is being used (not a VCN), then method 700 may proceed to 706 to process the transaction using a PAN. If a VCN is being used, then method 700 may proceed to 708 to process the transaction using a VCN.

In 706, financial services provider system 110 may verify the authenticity of a transaction using the PAN and the CVV that is associated with the PAN. Thus, in 706, the transaction may be verified using the information on credit card 200, i.e., PAN 202, CVV 214, and expiration date 212. However, this step exposes PAN 202 in the transaction, and no VCN is used in the transaction to further secure PAN 202.

In 708, financial services provider system 110 may proceed to process the transaction using a VCN, i.e., the VCN received in 702. In one approach, financial services provider system 110 may retrieve the CVV associated with the VCN, i.e., virtual card CVV 304, from storage 138 as previously generated by CVV generator 134. In another embodiment, financial services provider system 110 may generate the virtual card CVV using an appropriate security verification algorithm that derives the virtual card CVV based on the VCN and other accessible information. Appropriate security verification algorithms are described in further detail below.

In 710, financial service provider system 110 may verify the transaction using the VCN and the CVV that is associated with the VCN. In one approach, financial services provider system 110 may compare the CVV received in 702 with the virtual card CVV retrieved/generated in 708 to ensure that the entered VCN and the virtual card match and/or otherwise comply with the security protocols. For example, financial services provider system 110 may perform a security verification algorithm against virtual card CVV 304 to ensure that the received VCN and the received/retrieved CVV reflect an authorized transaction. In one approach, the security verification algorithm uses the VCN as a key to derive a value that needs to match the virtual card CVV. In such an approach, the VCN and CVV association may be verified cryptographically or algorithmically. Many suitable approaches exist to perform such a verification of the VCN/virtual CVV combination. In one simple example, the security verification algorithm uses the 4^{th}, 8^{th}, and 12^{th} digits of the VCN to create the virtual CVV. Many other approaches exist within the scope of this disclosure, e.g., using the VCN along other stored, verifiable factors such as date of birth, expiration date, zip code, etc., to derive a virtual CVV algorithmically or cryptographically. In some cases, the exact security verification algorithm employed may be protected to avoid reverse engineering attempts and other malfeasance conducted by fraudsters.

In 712, financial service provider system 110 may determine if the verification performed in 710 was successful. If verification was successful, then method 700 may proceed to 714 ending the method. However, if the initial verification was unsuccessful, then method 700 may proceed to 716 to verify the transaction using dual-CVV processing, i.e, using VCN and a linked CVV from the PAN.

In 716, financial service provider system 110 may retrieve a linked CVV associated with the PAN, e.g., the linked CVV may be CVV 214 associated with PAN 202. As discussed above, when creation module 132 generates a VCN, CVV generator 134 may create virtual card CVV 344. In addition to the virtual card CVV, the association or link between the VCN and the PAN's CVV may be stored in storage 138. In this embodiment, both the PAN's CVV and the VCN's CVV may be used by financial service provider system 110 when verifying transactions. In another embodiment, financial service provider system 110 may retrieve the PAN associated with the VCN and run a security verification algorithm against the retrieved PAN to derive a linked CVV associated with the PAN.

In 718, financial services provider system 110 may verify the authenticity of a transaction using the VCN and the linked CVV retrieved/generated in 716. In one approach, financial services provider system 110 may compare the CVV retrieved/generated in 716 with the CVV received in 702 to ensure that the entered information matches the retrieved/generated information. In one embodiment, financial services provider system 110 may perform a security verification algorithm against VCN 302 to derive a value that can be compared to the linked CVV. In another approach, financial services provider system 110 may perform a security verification algorithm against PAN 202 to derive a value that can be compared to the linked CVV. By linking the VCN to the PAN's CVV in this fashion and processing transactions using the linked CVV, from the perspective of user 102, only a single CVV need be remembered (i.e., the PAN's CVV).

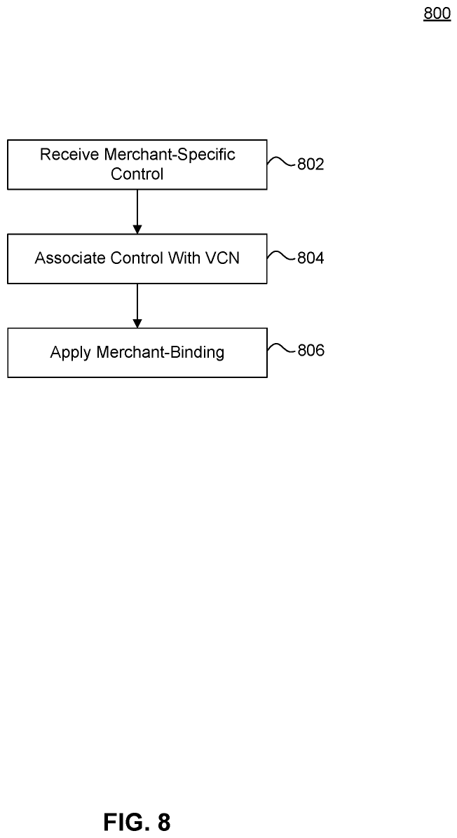

FIG. 8 illustrates a method 800 of applying merchant-specific controls to a VCN, in accordance with an embodiment. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art(s).

In 802, VCN component 130 may allow user 102 to specify a merchant-specific control to with a VCN. The merchant-specific control may identify a limitation that restricts the use of the VCN. For example, a merchant-specific control may be a spending limit, and any transactions that exceed the spending limit may be rejected by financial service provider system without attempting to process the transaction. Other examples of merchant may be a limit on the number of charges, date/time limitations, and other suitable controls.

In 804, VCN component 130 may associate the merchant-specific control with an existing VCN. VCN component 130 may store appropriate information in storage 138 for use in the later processing of transactions that use the VCN and the merchant-specific control entered in 802.

In 806, VCN component 130 may apply merchant binding in response to a transaction using the VCN. Merchant-binding may verify that the transaction is being applied to the appropriate merchant. If a VCN is associated with “merchant A” and the transaction involves “merchant B,” the transaction may be denied. VCN component may also verify that the transaction is valid by examining the merchant-specific controls provided by user 102 in 802. For example, if a spending limit has been applied and the transaction has a price in excess of the spending limit, then the charge may be denied.

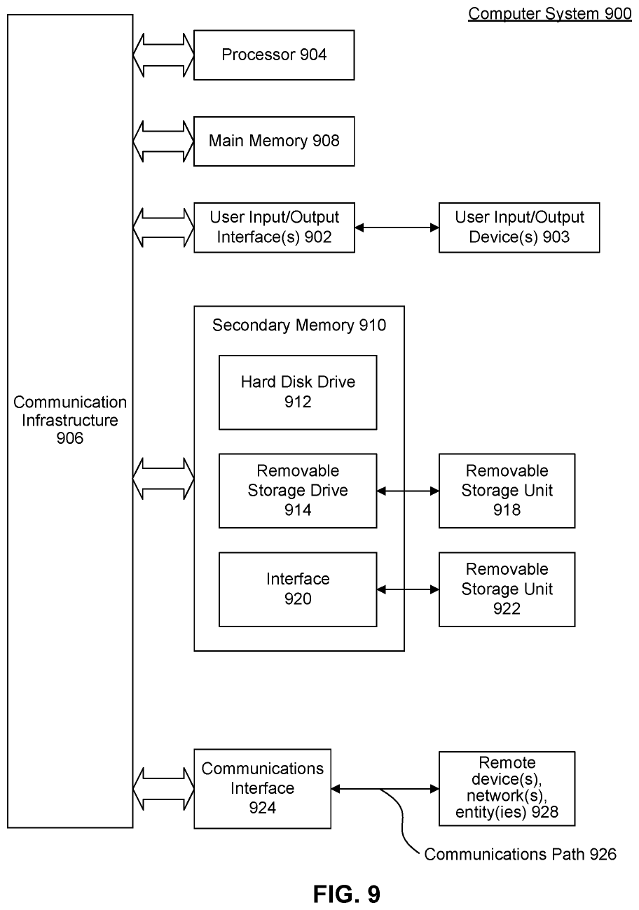

Various embodiments may be implemented, for example, using one or more well-known computer systems, such as computer system 900 shown in FIG. 9. One or more computer systems 900 may be used, for example, to implement any of the embodiments discussed herein, as well as combinations and sub-combinations thereof.

Computer system 900 may include one or more processors (also called central processing units, or CPUs), such as a processor 904. Processor 904 may be connected to a communication infrastructure or bus 906.

Computer system 900 may also include user input/output device(s) 908, such as monitors, keyboards, pointing devices, etc., which may communicate with communication infrastructure 906 through user input/output interface(s) 902.

One or more of processors 904 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 900 may also include a main or primary memory 908, such as random access memory (RAM). Main memory 908 may include one or more levels of cache. Main memory 908 may have stored therein control logic (i.e., computer software) and/or data.

Computer system 900 may also include one or more secondary storage devices or memory 910. Secondary memory 910 may include, for example, a hard disk drive 912 and/or a removable storage device or drive 914. Removable storage drive 914 may be a floppy disk drive, a magnetic tape drive, a compact disk drive, an optical storage device, tape backup device, and/or any other storage device/drive.

Removable storage drive 914 may interact with a removable storage unit 918. Removable storage unit 918 may include a computer usable or readable storage device having stored thereon computer software (control logic) and/or data. Removable storage unit 918 may be a floppy disk, magnetic tape, compact disk, DVD, optical storage disk, and/any other computer data storage device. Removable storage drive 914 may read from and/or write to removable storage unit 918.

Secondary memory 910 may include other means, devices, components, instrumentalities or other approaches for allowing computer programs and/or other instructions and/or data to be accessed by computer system 900. Such means, devices, components, instrumentalities or other approaches may include, for example, a removable storage unit 922 and an interface 920. Examples of the removable storage unit 922 and the interface 920 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 900 may further include a communication or network interface 924. Communication interface 924 may enable computer system 900 to communicate and interact with any combination of external devices, external networks, external entities, etc. (individually and collectively referenced by reference number 928). For example, communication interface 924 may allow computer system 900 to communicate with external or remote devices 928 over communications path 926, which may be wired and/or wireless (or a combination thereof), and which may include any combination of LANs, WANs, the Internet, etc. Control logic and/or data may be transmitted to and from computer system 900 via communication path 926.

Computer system 900 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 900 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 900, main memory 908, secondary memory 910, and removable storage units 918 and 922, as well as tangible articles of manufacture embodying any combination of the foregoing. Such control logic, when executed by one or more data processing devices (such as computer system 900), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 9. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A method for generating a virtual card number used to process transactions from a card account having a primary account number (PAN), comprising:
retrieving, by one or more processors, a trailing identifier that matches a trailing quantity of digits in the PAN such that the trailing quantity of digits are used by a consumer to identify the card account without revealing the PAN, wherein at least one of the trailing quantity of digits are a checksum value;
selecting, by the one or more processors, a bank identification number (BIN) from a plurality of available BINs;
determining, by the one or more processors, an account identifier;
concatenating the selected BIN, the account identifier, and the trailing identifier to generating the virtual card number, wherein the selecting the BIN and determining the account identifier occur such that, when concatenated, the virtual card number (i) is unique and (ii) satisfies the checksum value when a checksum algorithm is applied to the virtual card number; and
linking, by the one or more processors, a virtual card having the virtual card number with the card account.

2. The method of claim 1, the determining the account identifier further comprising:
selecting, by the one or more processors, the account identifier from a data structure of valid account identifiers that specifies valid account identifiers that satisfy the checksum algorithm when combined with the selected BIN and the trailing identifier.

3. The method of claim 2, further comprising:
building the data structure of valid account identifiers by:
(1) traversing the plurality of available BINS to determine a current BIN;
(2) traversing all trailing identifiers to determine a current trailing identifier;
(3) traversing all account identifiers to determine a current account identifier; and
(4) running the checksum algorithm and when the combination of the current BIN, the current trailing identifier, and the current account identifier satisfies the checksum algorithm, adding the current account identifier to the data structure of valid account identifiers, wherein the data structure is keyed using the current BIN and the current trailing identifier.

4. The method of claim 1, wherein the virtual card number is a sixteen-digit number, wherein the bank identification number is a six-digit number, wherein the account identifier is a five-digit number, wherein the trailing identifier is a four-digit number, and wherein the checksum value is a single-digit number.

5. The method of claim 1, wherein the virtual card number is a sixteen-digit number, wherein the bank identification number is an eight-digit number, the account identifier is a three-digit number, wherein the trailing identifier is a four-digit number, and wherein the checksum value is a single-digit number.

6. The method of claim 1, wherein the virtual card number is a twenty-digit number, wherein the bank identification number is an eight-digit number, wherein the account identifier is a seven-digit number, wherein the trailing identifier is a four-digit number, and wherein the checksum value is a single-digit number.

7. The method of claim 1, wherein the virtual card number is a twenty-digit number, wherein the bank identification number is an eight-digit number, wherein the account identifier is a six-digit number, wherein the trailing identifier is a four-digit number, and wherein the checksum value is a two-digit number.

8. The method of claim 1, wherein the virtual card number is a twenty-digit number, wherein the bank identification number is an eight-digit number, wherein the account identifier is a six-digit number, wherein the trailing identifier is a five-digit number, and wherein the checksum value is a single-digit number.

9. The method of claim 1, wherein the virtual card number is a twenty-digit number, wherein the bank identification number is an eight-digit number, wherein the account identifier is a five-digit number, wherein the trailing identifier is a six-digit number, and wherein the checksum value is a single-digit number.

10. The method of claim 1, wherein the card account further comprises a PAN card verification value (CVV), further comprising:
generating, by the one or more processors, a virtual CVV based on the virtual card number; and
linking, by the one or more processors, the virtual CVV and the PAN CVV with the virtual card.

11. The method of claim 10, further comprising:
verifying, the one or more processors, an authenticity of a subsequent transaction that uses the virtual card by performing a security verification algorithm against the virtual card number and matching the output of the security verification algorithm to either of the virtual CVV and the PAN CVV.

12. The method of claim 1, further comprising:
associating, by the one or more processors, the virtual card with a merchant.

13. The method of claim 12, further comprising:
receiving, by the one or more processors, a control from a user that specifies a limitation on transactions performed at the merchant using the virtual card; and
associating, by the one more processors, the control with the virtual card.

14. The method of claim 1, the linking further comprising:
retrieving, by the one or more processors, a first expiration date associated with the card account; and
setting, by the one or more processors, a second expiration date associated with the virtual card to the retrieved first expiration date.

15. The method of claim 1, the linking further comprising:
setting, by the one or more processors, an expiration date associated with the virtual card to a distant date.

16. The method of claim, wherein the (i) retrieving, (ii) selecting, (iii) determining, (iv) concatenating, and (v) linking are performed in response to a request from an application that recognizes a credit card field in a checkout page.

17. A system for generating a virtual card number used to process transactions from a card account having a primary account number (PAN), comprising:
a memory; and
at least one processor coupled to the memory configured to:
retrieve a trailing identifier that matches a trailing quantity of digits in the PAN such that the trailing quantity of digits are used by a consumer to identify the card account without revealing the PAN, wherein at least one of the trailing quantity of digits are a checksum value;
select a bank identification number (BIN) from a plurality of available BINs;
determine an account identifier;
concatenate the selected BIN, the account identifier, and the trailing identifier to generating the virtual card number, wherein the selecting the BIN and determining the account identifier occur such that, when concatenated, the virtual card number (i) is unique and (ii) satisfies the checksum value when a checksum algorithm is applied to the virtual card number; and
link a virtual card having the virtual card number with the card account.

18. The system of claim 17, wherein to determine the account identifier the at least one processor further configured to:
select the account identifier from a data structure of valid account identifiers that specifies valid account identifiers that satisfy the checksum algorithm when combined with the selected BIN and the trailing identifier.

19. The system of claim 18, the at least one processor further configured to:
build the data structure of valid account identifiers by:
(1) traversing the plurality of available BINS to determine a current BIN;
(2) traversing all trailing identifiers to determine a current trailing identifier;
(3) traversing all account identifiers to determine a current account identifier; and
(4) running the checksum algorithm and when the combination of the current BIN, the current trailing identifier, and the current account identifier satisfies the checksum algorithm, adding the current account identifier to the data structure of valid account identifiers, wherein the data structure is keyed using the current BIN and the current trailing identifier.

20. A non-transitory computer-readable storage medium having computer-executable instructions stored thereon that, in response to being executed by a computing device, cause the computing device to perform operations for generating a virtual card number used to process transactions from a card account having a primary account number (PAN), the operations comprising:
retrieving a trailing identifier that matches a trailing quantity of digits in the PAN such that the trailing quantity of digits are used by a consumer to identify the card account without revealing the PAN, wherein at least one of the trailing quantity of digits are a checksum value;
selecting a bank identification number (BIN) from a plurality of available BINs;
determining an account identifier;
concatenating the selected BIN, the account identifier, and the trailing identifier to generating the virtual card number, wherein the selecting the BIN and determining the account identifier occur such that, when concatenated, the virtual card number (i) is unique and (ii) satisfies the checksum value when a checksum algorithm is applied to the virtual card number; and
linking a virtual card having the virtual card number with the card account.
